(19) United States
(12) Patent Application Publication
(10) Pub. No.: US 2026/0365230 A1
(43) Pub. Date: Nov. 19, 2026

(54) REVERSE INPUT PREVENTION DEVICE AND REAR WHEEL STEERING DEVICE INCLUDING SAME

(71) Applicant: HYUNDAI MOBIS CO., LTD., Seoul (KR)

(72) Inventor: Tae Yoon KIM, Yongin-si (KR)

(73) Assignee: HYUNDAI MOBIS CO., LTD., Seoul (KR)

(21) Appl. No.: 19/246,278

(22) Filed: Jun. 23, 2025

(30) Foreign Application Priority Data
May 13, 2025 (KR) 10-2025-0062061

(51) Int. Cl. B62D 5/04; F16D 41/02

(52) U.S. Cl. CPC B62D 5/043; B62D 5/0421; B62D 5/0442; F16D 41/02

(57) ABSTRACT

A reverse input prevention device includes a disk housing including a plurality of disk housing grooves, an input part that is disposed in the disk housing and rotates around a rotation shaft, a disk part that revolves around the rotation shaft by the rotation of the input part and rotates by contacting the disk housing grooves, and an output part that includes a plurality of output gear grooves contacting the disk part and rotates around the rotation shaft.

### CROSS-REFERENCE TO RELATED APPLICATIONS

The present application claims priority and the benefit of Korean Patent Application No. 10-2025-0062061, filed on May 13, 2025, in the Korean Intellectual Property Office, the entire disclosure of which is incorporated herein by reference.

### TECHNICAL FIELD

The present disclosure relates to a reverse input prevention device and a rear wheel steering device including the same, and more specifically, to a reverse input prevention device that prevents reverse input from a rear wheel and a rear wheel steering device including the same.

### BACKGROUND

The steering device is developing into a form of steer-by-wire that is not directly mechanically connected to the steering wheel operated by a driver. As the technology of steer-by-wire is developing, the technology for the rear wheel steering (RWS) is also developing. The rear wheel steering device is included in an all-wheel steering (AWS) device that may improve the vehicle's responsiveness and driving safety and reduce the turning radius.

In general, the rear wheel steering device of a vehicle has a structure in which a steering shaft is coupled to a screw nut. A male screw pattern is formed on the steering shaft, and a female screw pattern that meshes with the male screw pattern of the steering shaft is formed on the screw nut. When the screw nut is rotated by a driving part, the steering shaft moves axially, and the rear wheels of the vehicle are steered by the operation of the steering shaft.

Unlike front wheels, the rear wheels are not mechanically connected to the steering wheel operated by the user, so the steering angle of the rear wheels may change not only by the user's operation but also by an external force. A rear wheel steering device is required to prevent this problem.

The background technology of the present disclosure is disclosed in Korean Patent Publication No. 10-2018-0120447 (published on Nov. 6, 2018, entitled “REAR WHEEL STEERING DEVICE”).

### SUMMARY

The present disclosure provides a reverse input prevention device that prevents a steering angle of a rear wheel from being changed due to an external force and a rear wheel steering device including the same.

In addition, the present disclosure provides a reverse input prevention device having a deceleration function and a rear wheel steering device including the same.

A reverse input prevention device according to the present disclosure may include a disk housing including a plurality of disk housing grooves, an input part that is disposed in the disk housing and rotates around a rotation shaft, a disk part that revolves around the rotation shaft by the rotation of the input part and rotates by contacting the disk housing grooves, and an output part that includes a plurality of output gear grooves contacting the disk part and rotates around the rotation shaft.

The input part may include an input shaft extending in a direction parallel to the rotation shaft, and an eccentric shaft connected to the input shaft and revolving around the rotation shaft by the rotation of the input shaft.

The disk part may include a disk body, and a disk body hole provided as a hole penetrating the disk body, the input part being inserted into the disk body hole.

The disk body may include an input disk including a plurality of input disk teeth that contact the disk housing grooves, and an output disk including a plurality of output disk teeth that contact the output gear grooves and rotating in conjunction with the input disk.

The number of disk housing grooves may be greater than the number of input disk teeth.

The number of input disk teeth may be greater than the number of output disk teeth.

The output part may include an output shaft extending in a direction parallel to the rotation shaft and rotating around the rotation shaft, and an output gear body connected to the output shaft, rotating by contacting the output disk of the rotating disk part, and including the output gear grooves.

The number of output gear grooves may be greater than the number of output disk teeth disposed on the output disk.

An angular speed of the rotating input part may be greater than the angular speed of the rotating output part, a driving force transmitted through the input part may rotate the disk part and the output part, and an external force transmitted through the output part may be prevented from being transmitted to the output part, the disk part, and the input part.

A rear wheel steering device according to the present disclosure may include a driving part that generates a driving force, a transmission part connected to the driving part to transmit the driving force, a steering part connected to the transmission part to adjust a steering angle by the driving force, and a reverse input prevention device that is disposed between the driving part and the transmission part and prevents a reverse input transmitted from the transmission part to the driving part. The reverse input prevention device may include a disk housing having a plurality of disk housing grooves, an input part that is disposed in the disk housing and rotates around a rotation shaft, a disk part that revolves around the rotation shaft by the rotation of the input part and rotates by contacting the disk housing grooves, and an output part that includes a plurality of output gear grooves contacting the disk part and rotates around the rotation shaft.

The input disk and the output disk may revolve around the rotation shaft in a first direction by the input part that rotates around the rotation shaft in the first direction, the input disk and the output disk that contact the disk housing may rotate in a second direction opposite to the first direction, and the output part that contacts the output disk rotating in the second direction may rotate around the rotation shaft in the first direction.

The number of disk housing grooves may be one more than the number of input disk teeth.

The number of input disk teeth and the number of output disk teeth may be coprime.

The number of input disk teeth may be one more than the number of output disk teeth.

The number of output gear grooves may be one more than the number of output disk teeth.

The reverse input prevention device according to the present disclosure and the rear wheel steering device including the same may prevent the steering angle of the rear wheel from being changed.

### BRIEF DESCRIPTION OF THE DRAWINGS

FIG. 1 is a perspective view of a rear wheel steering device according to an embodiment of the present disclosure.

FIG. 2 is a perspective view of a part of a rear wheel steering device according to an embodiment of the present disclosure.

FIG. 3 is a perspective view of a reverse input prevention device according to an embodiment of the present disclosure.

FIG. 4 is a cross-sectional view of a reverse input prevention device according to an embodiment of the present disclosure.

FIG. 5 is an exploded perspective view of a reverse input prevention device according to an embodiment of the present disclosure from a first viewpoint.

FIG. 6 is an exploded perspective view of the reverse input prevention device according to an embodiment of the present disclosure from a second viewpoint.

FIGS. 7 to 12 are cross-sectional views illustrating that a reverse input prevention device rotates by a driving force according to an embodiment of the present disclosure.

FIG. 13 is a cross-sectional view illustrating that a reverse input prevention device blocks a reverse input according to an embodiment of the present disclosure.

FIG. 14 is a perspective view of a rear wheel steering device according to another embodiment of the present disclosure.

### DETAILED DESCRIPTION

Hereinafter, with reference to the accompanying drawings, a rear wheel steering device and a reverse input prevention device according to the present disclosure will be described. In this process, the thickness of the lines and the size of the components in the drawings may be exaggeratedly illustrated for clarity and convenience of description. In addition, the terms to be described below are terms defined in consideration of the functions in the present disclosure, and these may vary depending on the intention of the user or operator or custom. Accordingly, the definition of these terms should be made based on the overall contents of the specification.

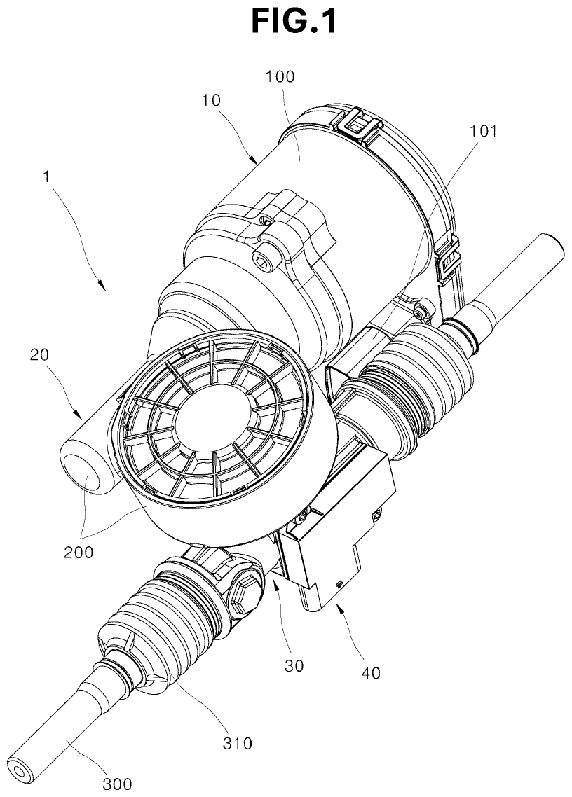

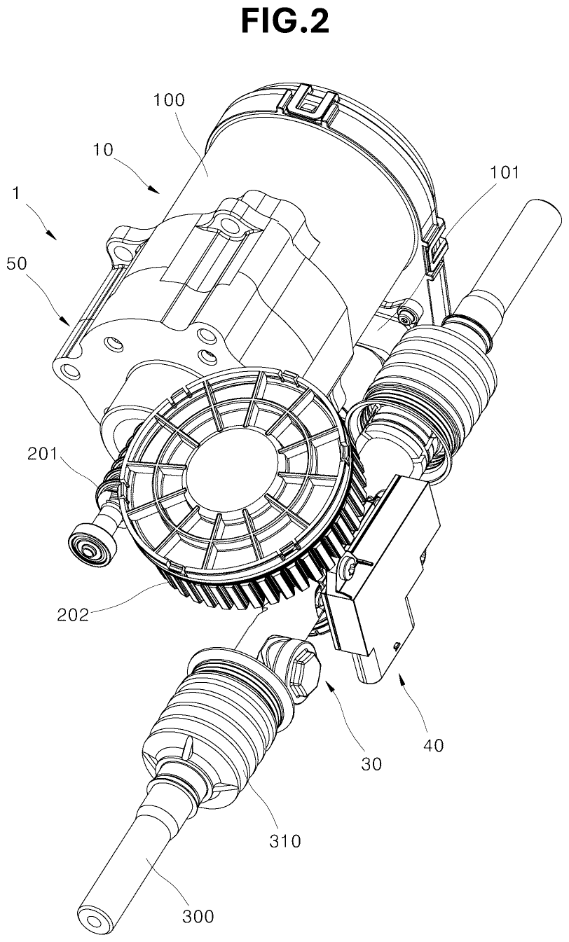

FIG. 1 is a perspective view of a rear wheel steering device 1 according to an embodiment of the present disclosure, and FIG. 2 is a perspective view of a part of the rear wheel steering device 1 according to an embodiment of the present disclosure.

Referring to FIGS. 1 and 2, the rear wheel steering device 1 is described.

The rear wheel steering device 1 includes a driving part 10, a transmission part 20, a steering part 30, and a reverse input prevention device 50.

The driving part 10 includes a driving part housing 100, a driving part connector 101, and a motor (not shown).

The motor is disposed inside the driving part housing 100, and the driving part connector 101 connected to the motor is disposed outside the driving part housing 100.

The driving part connector 101 is connected to the motor, and a power or a signal required for driving the motor is transmitted to the motor through the driving part connector 101.

The driving force may be generated by driving the motor. The driving force is transmitted to the reverse input prevention device 50. The driving force may be provided as a rotational force that rotates the reverse input prevention device 50.

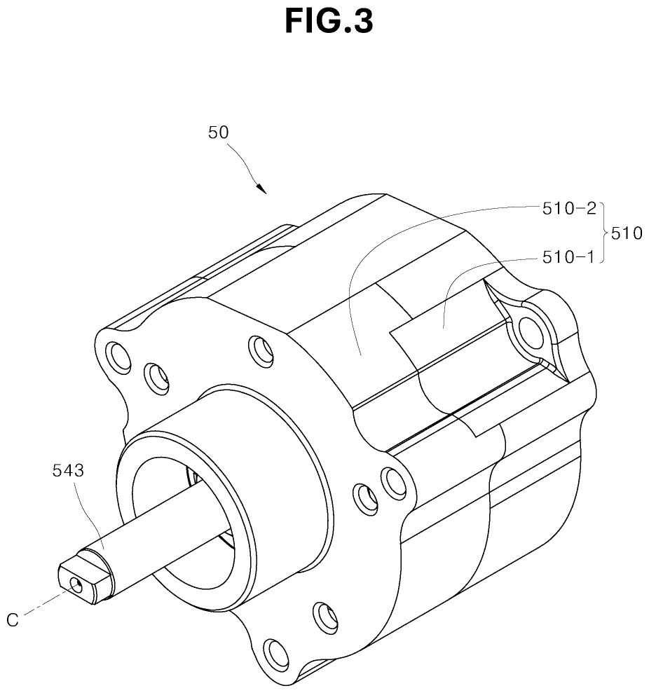

The reverse input prevention device 50 rotates around a rotation shaft (the rotation shaft C of FIG. 3) by the driving force. The reverse input prevention device 50 transmits the driving force to the transmission part 20.

The transmission part 20 includes a transmission part housing 200, a first gear 201, and a second gear 202.

The first gear 201 and the second gear 202 are disposed inside the transmission part housing 200. The transmission part housing 200 may be integrally formed or may be provided as a plurality of housings.

The first gear 201 is connected to the reverse input prevention device 50 to rotate.

According to an embodiment, the second gear 202 may rotate by meshing with the first gear 201 (refer to FIG. 2). The first gear 201 and the second gear 202 may be provided as a worm gear and a worm wheel.

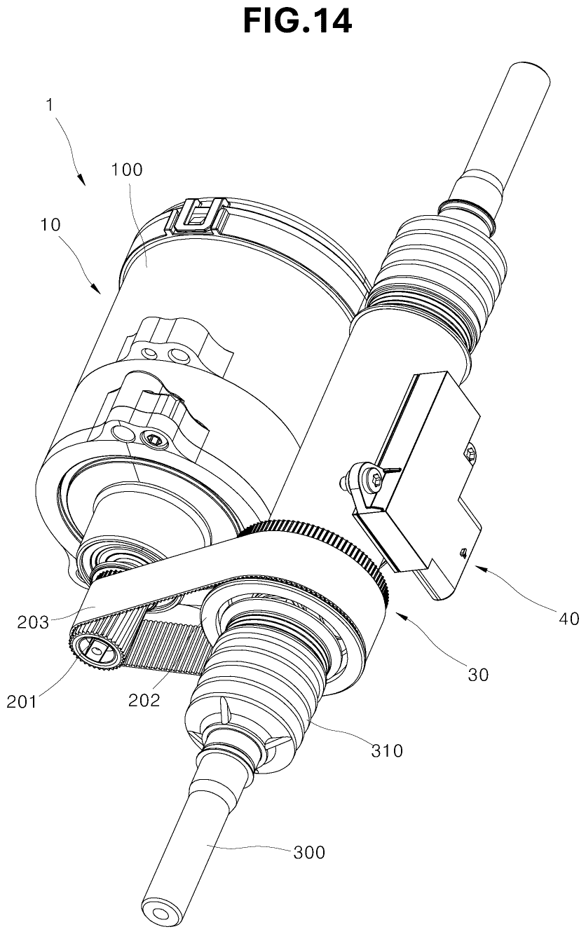

According to another embodiment, the first gear 201 and the second gear 202 may be provided as a combination of a gear (e.g., a pinion gear) and a belt 203 (refer to FIG. 14). Embodiments of the first gear 201 and the second gear 202 are not limited thereto, and may include other embodiments.

The driving force transmitted from the reverse input prevention device 50 to the transmission part 20 is transmitted to the steering part 30. The steering part 30 receives the driving force and converts the driving force into a linear motion in which the steering part 30 moves in a direction parallel to one direction. The steering angles of tires included in the vehicle (not shown) may be adjusted by the linear motion of the steering part 30.

The gear included in the transmission part 20 and the gear included in the steering part 30 meshes with each other, and the gear included in the steering part 30 moves linearly. The gear included in the steering unit 30 is connected to a steering bar 300, and the steering bar 300 linearly moves in parallel in one direction.

According to an embodiment, the gear of the transmission part 20 and the gear of the steering part 30 may be provided as a combination of a pinion gear, a rack gear, a lead screw, and/or a ball screw. The gear of the transmission part 20 and the gear of the steering part 30 are not limited thereto, and may include other embodiments.

The steering part 30 includes a foreign matter prevention unit 310. The foreign matter prevention unit 310 is disposed to surround the outer circumference of the steering bar 300 to prevent external foreign matters from flowing into the steering part 30. The foreign matter prevention unit 310 may be formed to be wrinkled, and accordingly, even if the length of the foreign matter prevention unit 310 is changed, the foreign matter prevention unit 310 may not be damaged. According to an embodiment, the shape of the foreign matter prevention unit 310 may be provided in a bellows shape.

A tire that is not mechanically connected to a steering device (e.g., a steering wheel) may have a different steering angle due to an external force (e.g., a road surface, etc.). Since such a change in the steering angle is not intended by the driver, it is necessary to limit the change.

The linear motion of the steering part 30 by the steering angle of the tire may be transmitted to the transmission part 20 as an external force. The external force may be transmitted from the transmission part 20 to the reverse input prevention device 50. The reverse input prevention device 50 may block the external force. Accordingly, it is possible to prevent the external force from being transmitted to the driving part 10.

The rear wheel steering device 1 may further include a sensor part 40.

The sensor part 40 senses the position of the steering bar 300. The sensor part 40 is disposed on the steering part 30 to sense the position of the steering bar 300, and acquires information on the steering angle of the tire through the sensed position of the steering bar 300.

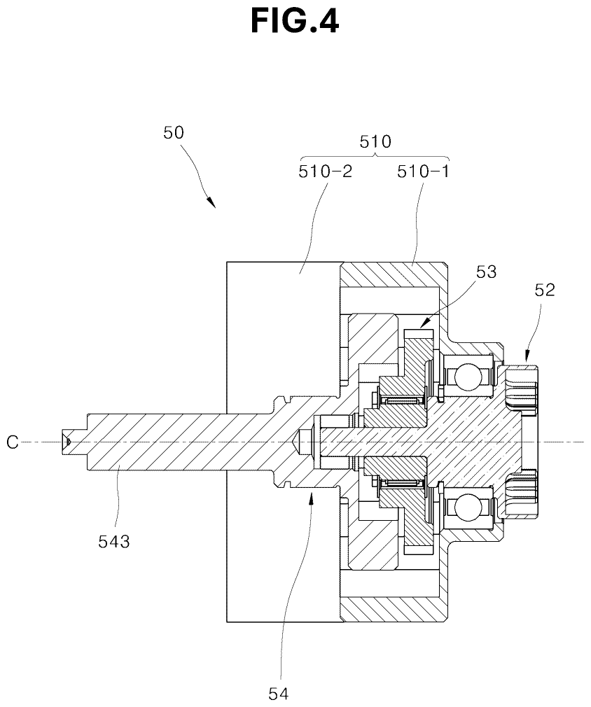

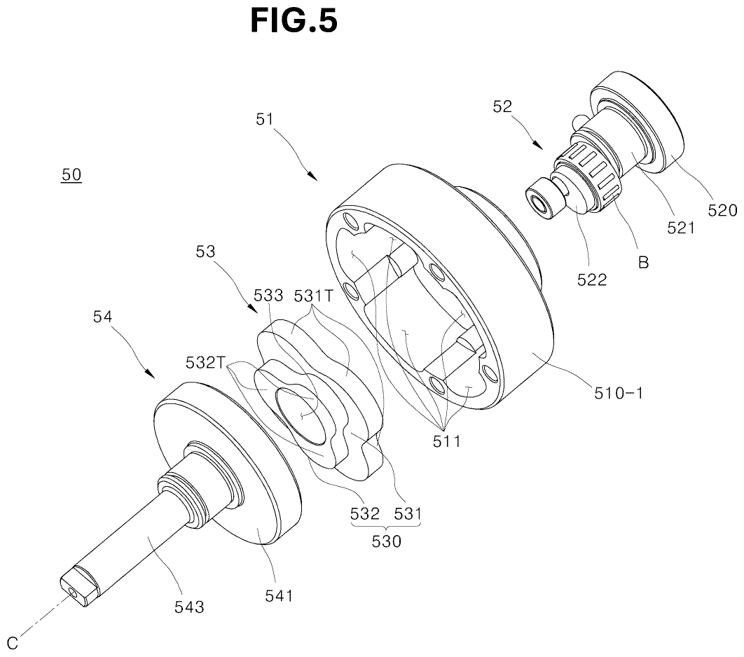

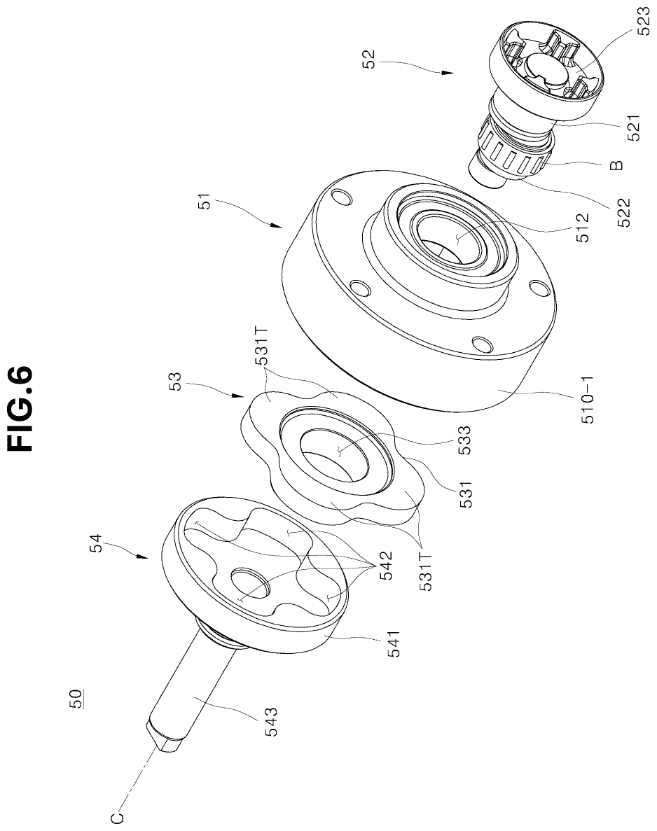

FIG. 3 is a perspective view of a reverse input prevention device 50 according to an embodiment of the present disclosure, FIG. 4 is a cross-sectional view of the reverse input prevention device 50 according to an embodiment of the present disclosure, FIG. 5 is an exploded perspective view of the reverse input prevention device 50 according to an embodiment of the present disclosure from a first viewpoint, and FIG. 6 is an exploded perspective view of the reverse input prevention device 50 according to an embodiment of the present disclosure from a second viewpoint.

Referring to FIGS. 3 to 6, the reverse input prevention device 50 is described.

The reverse input prevention device 50 includes a disk housing 51, an input part 52, a disk part 53, and an output part 54.

The disk part 53 is disposed inside the disk housing 51 to rotate, and the input part 52 and the output part 54 are inserted into the disk housing 51 to rotate around a rotation shaft C.

The disk housing 51 includes a first disk housing 510-1 and a second disk housing 510-2.

Disk housing grooves 511 are disposed inside the disk housing 51. A plurality of disk housing grooves 511 may be disposed around the rotation shaft C. The plurality of disk housing grooves 511 are disposed at equal intervals around the rotation shaft C. According to an embodiment, five disk housing grooves 511 may be provided. The number of disk housing grooves 511 is not limited to five, and the disk housing grooves 511 may be provided in various numbers.

The disk housing grooves 511 are in contact with the disk part 53. According to an embodiment, the disk housing grooves 511 may be in contact with an input disk 531 of the disk part 53. More specifically, the disk housing grooves 511 may be in contact with input disk teeth 531T of the input disk 531. The input disk teeth 531T may contact the disk housing grooves 511 so that the disk part 53 may rotate around an eccentric shaft 522. The eccentric shaft 522 may revolve around the rotation shaft C.

A disk housing hole 512 is provided to penetrate the disk housing 51. According to an embodiment, the disk housing hole 512 may penetrate the disk housing 51, parallel to the direction of the rotation shaft C. The disk housing hole 512 may be disposed in the first disk housing 510-1 and/or the second disk housing 510-2.

The input part 52 and/or the output part 54 are/is disposed to penetrate the disk housing hole 512. The input part 52 and/or the output part 54 penetrating the disk housing hole 512 rotate(s) around the rotation shaft C. According to an embodiment, the input part 52 and/or the output part 54 may rotate around the rotation shaft C.

The input part 52 receives a driving force from the driving part 10. According to an embodiment, the input part 52 may rotate by the driving force of the driving part 10. More specifically, the input part 52 may rotate around the rotation shaft C by the driving force.

The input part 52 includes an input body 520, an input shaft 521, and an eccentric shaft 522.

The input body 520 extends in a direction parallel to the rotation shaft C. The input body 520 rotates around the rotation shaft C.

The input shaft 521 protrudes from the input body 520 in a direction parallel to the rotation shaft C. According to an embodiment, the input shaft 521 may be disposed opposite to the driving part 10 around the input body 520. The input shaft 521 may be inserted into the first disk housing 510-1. According to an embodiment, the input shaft 521 may be inserted into the disk housing hole 512 penetrating the first disk housing 510-1.

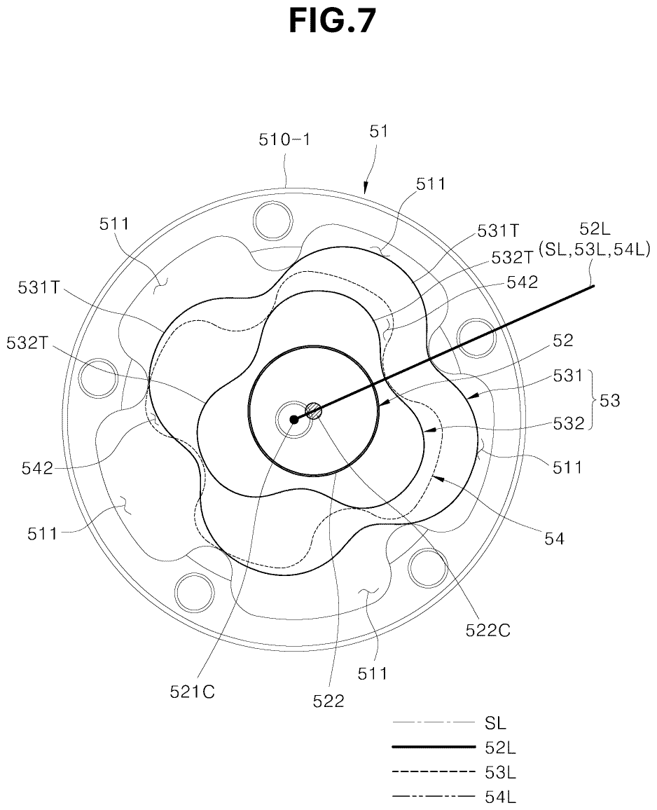

The center of the input shaft 521 may be defined as an input shaft center (e.g., an input shaft center 521C of FIG. 7). The input shaft center 521C may be disposed to coincide with the rotation shaft C. The input shaft 521 may have an approximately cylindrical shape.

The eccentric shaft 522 is connected to the input shaft 521. The eccentric shaft 522 may revolve around the input shaft center 521C by the rotation of the input shaft 521.

The center of the eccentric shaft 522 may be defined as an eccentric shaft center (e.g., an eccentric shaft center 522C of FIG. 7). The eccentric shaft center 522C may be spaced apart from the rotation shaft C or the input shaft center 521C. As the input shaft 521 rotates, the eccentric shaft center 522C may revolve around the rotation shaft C. The eccentric shaft 522 may have an approximately cylindrical shape.

The eccentric shaft 522 is inserted into the disk part 53. According to an embodiment, the eccentric shaft 522 may be inserted into a disk body hole 533 formed to be concave in the disk part 53. As the eccentric shaft 522 is inserted into the disk body hole 533 and revolves around the rotation shaft C, the disk part 53 may revolve around the rotation shaft C. As the disk part 53 revolves around the rotation shaft C and the input disk teeth 531T formed in the input disk 531 of the disk part 53 mesh with the disk housing grooves 511, the disk part 53 may rotate.

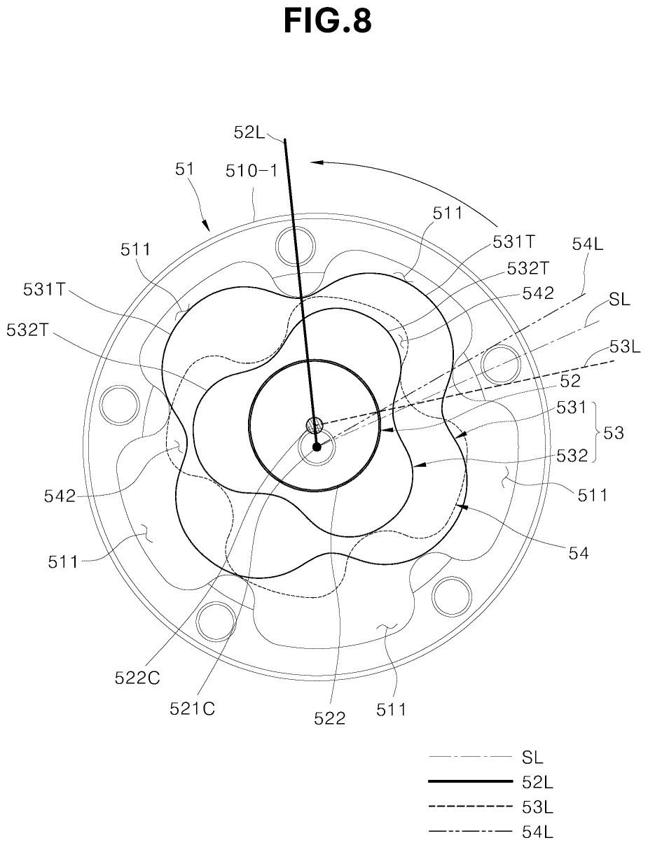

When the input shaft 521 rotates in a first direction (e.g., counterclockwise based on FIG. 8), the eccentric shaft 522 revolves in the first direction around the rotation shaft C, when the eccentric shaft 522 revolves around the rotation shaft C in the first direction, the disk part 53 revolves around the rotation shaft C in the first direction, and when the disk part 53 revolves around the rotation shaft C in the first direction, the input disk teeth 531T and the disk housing grooves 511 mesh each other, so that the input disk 531 may rotate in a second direction (e.g., clockwise based on FIG. 8) opposite to the first direction around the eccentric shaft center 522C. When the input disk 531 rotates in the second direction around the eccentric shaft center 522C, an output disk 532 rotating in conjunction with the input disk 531 may rotate in the second direction around the eccentric shaft center 522C and revolve in the first direction around the rotation shaft C. When the output disk 532 rotates in the second direction around the eccentric shaft center 522C and revolves in the first direction around the rotation shaft C, output disk teeth 532T formed in the output disk 532 may mesh with output gear grooves 542 formed in the output part 54 so that the output part 54 may rotate in the first direction around the rotation shaft C.

The input part 52 further includes an input joint 523. The input joint 523 is in contact with the driving part 10. The input part 52 receives the driving force from the driving part 10 through the input joint 523 in contact with the driving part 10 and rotates around the rotation shaft C.

The input part 52 is inserted into the output part 54. As the input part 52 is inserted into the output part 54, the rotation center of the input part 52 and the rotation center of the output part 54 may coincide. The angular speed of the rotating input part 52 can be made greater than the angular speed of the rotating output part 54.

The disk part 53 includes a disk body 530 and a disk body hole 533.

The disk body hole 533 may be provided as a hole penetrating the disk body 530.

The input part 52 is inserted into the disk body hole 533. According to an embodiment, the eccentric shaft 522 may be inserted into the disk body hole 533. More specifically, a bearing B may be disposed in the disk body hole 533, and the eccentric shaft 522 may be inserted into the bearing B.

The disk body 530 includes the input disk 531 and the output disk 532.

The input disk 531 may be disposed closer to the input part 52 than the output part 54, and the output disk 532 may be disposed closer to the output part 54 than the input part 52.

The input disk 531 and the output disk 532 may be integrally formed.

The input disk teeth 531T is disposed on the outer periphery of the input disk 531, and the input disk teeth 531T mesh with the disk housing grooves 511.

The output disk teeth 532T are disposed on the outer periphery of the output disk 532, and the output disk teeth 532T mesh with the output gear grooves 542 of the output part 54.

As the disk body 530 revolves around the input shaft center 521C, and the input disk teeth 531T disposed on the revolving disk body 530 mesh with the disk housing grooves 511 to rotate around the eccentric shaft center 522C, the output disk 532 may rotate around the rotation shaft C.

The number of input disk teeth 531T and the number of output disk teeth 532T may be provided in plural. The number of input disk teeth 531T and the number of output disk teeth 532T may be provided differently.

The output part 54 includes an output gear body 541 and output gear grooves 542. The output gear grooves 542 are disposed inside the output gear body 541. The output gear grooves 542 mesh with the output disk teeth 532T to rotate. More specifically, the output gear grooves 542 that mesh with the output disk teeth 532T may rotate around the rotation shaft C.

The output part 54 further includes an output shaft 543. The output shaft 543 is connected to the output gear body 541 and extends in a direction parallel to the rotation shaft C. The center of the output shaft 543 may coincide with the rotation shaft C.

The output gear grooves 542 may be provided in plural. According to an embodiment, the number of the output gear grooves 542 may be greater than that of the output disk teeth 532T. More specifically, the number of the output gear grooves 542 may be one more than that of the output disk teeth 532T.

Hereinafter, the number of the disk housing grooves 511, the number of the input disk teeth 531T, the number of the output disk teeth 532T, and the number of the output gear grooves 542 are described.

The number of the disk housing grooves 511 may be greater than that of the input disk teeth 531T, the number of the output disk teeth 532T may be less than that of the input disk teeth 531T, and the number of the output gear grooves 542 may be greater than that of the output disk teeth 532T.

The number of the disk housing grooves 511 may be greater than that of the input disk teeth 531T. According to an embodiment, the number of the disk housing grooves 511 may be one more than that of the input disk teeth 531T.

The number of the input disk teeth 531T may be greater than that of the output disk teeth 532T. According to an embodiment, the number of the input disk teeth 531T may be coprime to that of the output disk teeth 532T. According to another embodiment, the number of the input disk teeth 531T may be one more than that of the output disk teeth 532T. According to another embodiment, when the number of the input disk teeth 531T is divided by that of the output disk teeth 532T, it may be an infinite decimal number.

The number of the output gear grooves 542 may be greater than that of the output disk teeth 532T. According to an embodiment, the number of the output gear grooves 542 may be one more than that of the output disk teeth 532T.

Through the above configuration, the rotation ratio of the input shaft 521 and the output shaft 543 may be changed. As the rotation ratio of the input shaft 521 and the output shaft 543 is changed, the reverse input prevention device 50 may perform the function of a reducer.

The reduction ratio of the reverse input prevention device 50 may be as follows.

Reduction ratio=1/(1−((the number of the disk housing grooves 511)/(the number of the input disk teeth 531T))*((the number of the output disk teeth 532T)/(the number of the output gear grooves 542))):1

As illustrated in FIGS. 5 and 6, when the number of the disk housing grooves 511 is 5, the number of the input disk teeth 531T is 4, the number of the output disk teeth 532T is 3, and the number of the output gear grooves 542 is 4, the reduction ratio of the reverse input prevention device 50 may be 16:1.

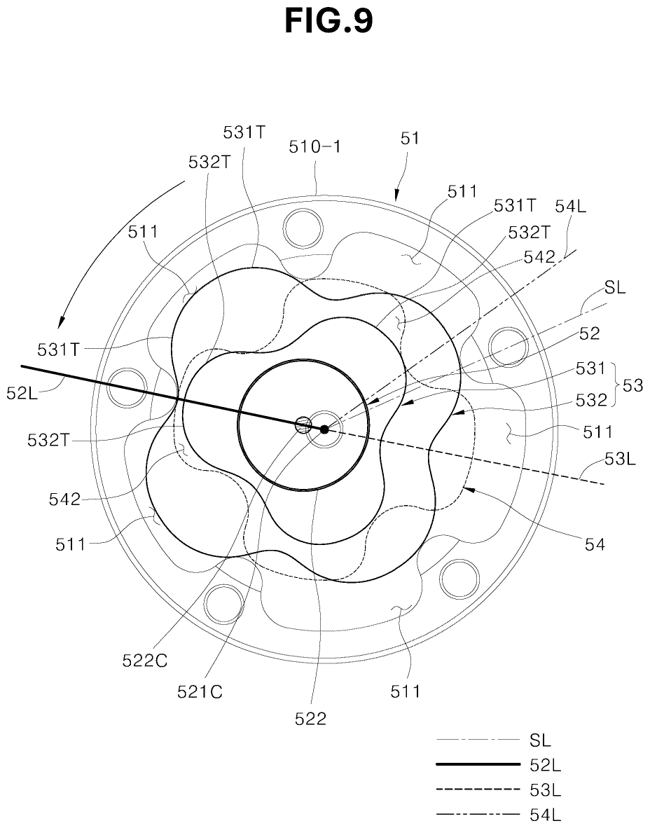

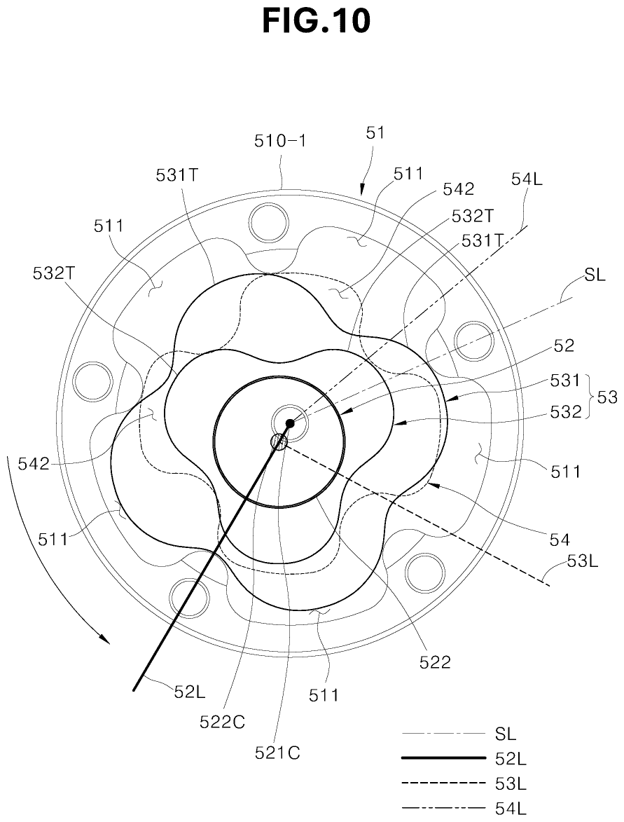

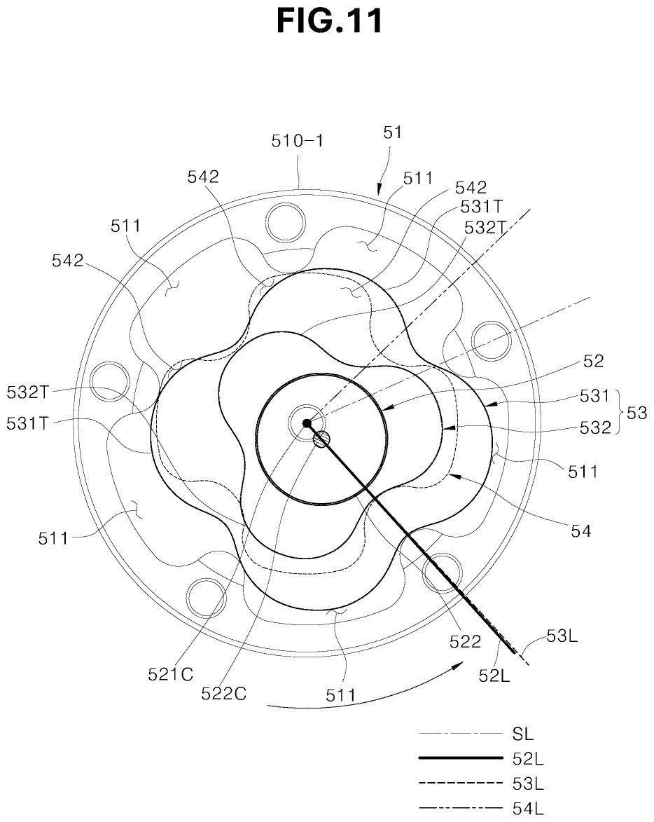

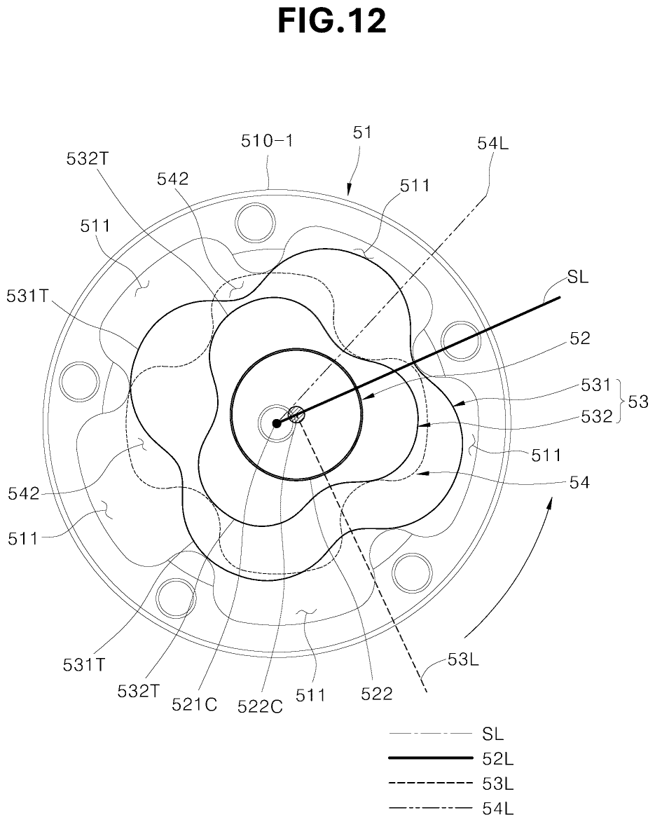

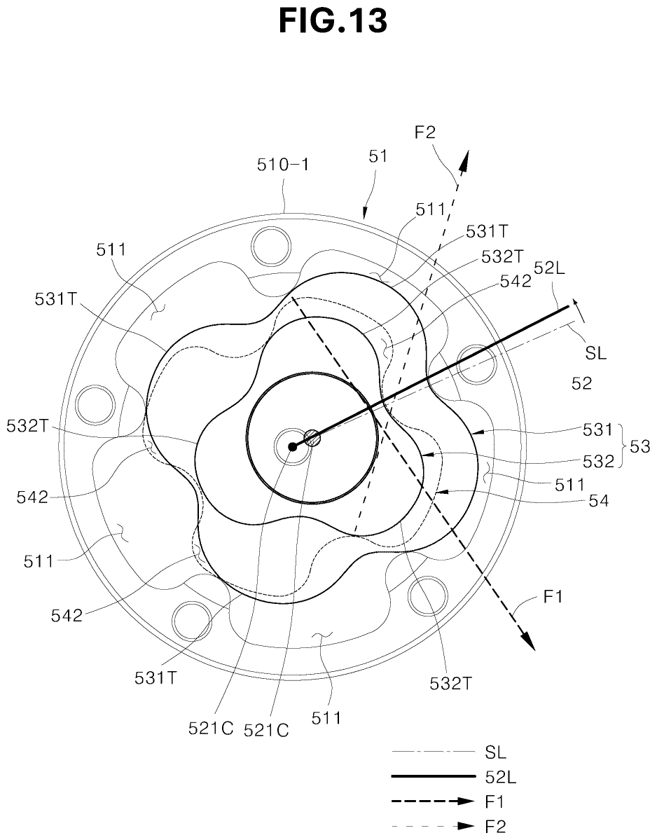

FIGS. 7 to 12 are cross-sectional views illustrating that a reverse input prevention device rotates by a driving force according to an embodiment of the present disclosure, and FIG. 13 is a cross-sectional view illustrating that the reverse input prevention device blocks reverse input according to an embodiment of the present disclosure.

Referring to FIGS. 7 to 12, the rotation of the input part 52, disk part 53, and output part 54 is described.

A reference line SL is a virtual line for determining the degree of rotation of the input part 52, the disk part 53, and the output part 54 and is illustrated in FIGS. 7 to 13.

An input part reference line 52L is a virtual line for determining the degree of rotation of the input part 52, a line extending from the input shaft center 521C toward the eccentric shaft center 522C, and is illustrated in FIGS. 7 to 13.

A disk part reference line 53L is a virtual line for determining the degree of rotation of the disk part 53, a line extending from the eccentric shaft center 522C toward a part of the disk part 53, and is illustrated in FIGS. 7 to 13.

An output part reference line 54L is a virtual line for determining the degree of rotation of the output part 54, a line extending from the input shaft center 521C toward a part of the output part 54, and is illustrated in FIGS. 7 to 13.

The driving force is transmitted to the input part 52 through the driving part 10. According to an embodiment, the driving force generated by the driving part 10 may be transmitted to the input body 520 through the input joint 523 to rotate the input body 520.

The input body 520 rotates in a first direction (e.g., counterclockwise based on FIG. 8). As the input body 520 rotates, the eccentric shaft 522 may revolve in the first direction around the rotation shaft C. The rotation shaft C and the input shaft center 521C may coincide with each other.

As the eccentric shaft 522 revolves around the rotation shaft C in the first direction, the disk part 53 into which the eccentric shaft 522 is inserted may also revolve around the rotation shaft C in the first direction.

As the disk part 53 revolves around the rotation shaft C in the first direction, the input disk teeth 531T disposed outside the input disk 531 mesh with the disk housing grooves 511 to rotate. As the input disk teeth 531T and the disk housing grooves 511 mesh and rotate, the disk part 53 rotates in a second direction (e.g., clockwise based on FIG. 8) opposite to the first direction around the eccentric shaft center 522C. According to an embodiment, the disk part 53 may rotate in the second direction around the eccentric shaft center 522C.

The input disk 531 and the output disk 532 rotate in conjunction with each other. Accordingly, the output disk 532 also revolves in the first direction around the input shaft center 521C and rotate in the second direction around the eccentric shaft center 522C.

The output disk teeth 532T disposed outside the output disk 532 that revolves in the first direction around the input shaft center 521C and rotates in the second direction around the eccentric shaft center 522C may mesh with the output gear grooves 542 of the output part 54 to rotate the output part 54. According to an embodiment, the output part 54 may rotate in the first direction around the input shaft center 521C.

The rotation ratio of the input part 52 and the output part 54 may vary depending on the number of the disk housing grooves 511, the number of the input disk teeth 531T, the number of the output disk teeth 532T, and the number of the output gear grooves 542. In FIGS. 7 to 13, the rotation ratio of the input part 52 and the output part 54 may be 16:1.

Referring to FIGS. 7 to 12, as the input part 52 rotates in the first direction, the input part reference line 52L rotates in the first direction around the input shaft center 521C.

As the input part 52 rotates in the first direction, the eccentric shaft center 522C rotates in the first direction around the input shaft center 521C. While the eccentric shaft center 522C revolves around the input shaft center 521C in the first direction, the input disk teeth 531T of the input disk 531 mesh with the disk housing grooves 511 to rotate in the second direction opposite to the first direction around the eccentric shaft center 522C. Accordingly, the disk part reference line 53L rotates in the second direction around the eccentric shaft center 522C.

As the disk part reference line 53L rotates in the second direction around the eccentric shaft center 522C, the output disk 532 also rotates in the second direction around the eccentric shaft center 522C. As the output disk 532 rotates in the second direction around the eccentric shaft center 522C, the output disk teeth 532T disposed in the output disk 532 mesh with the output gear grooves 542 of the output part 54 to rotate the output part 54. Accordingly, the output part 54 rotates in the first direction around the input shaft center 521C.

In this way, the rotation ratio of the input part 52 and the output part 54 in the reverse input prevention device 50 may be configured to a ratio other than 1:1 by the rotation of the input part 52, the rotation and revolution of the disk part 53, and the rotation of the output part 54.

Referring to FIG. 13, the process of preventing reverse input in the reverse input prevention device 50 is described.

An external force may be transmitted to the tires by an external environment (e.g., a road surface) of the tires supporting the vehicle. The external force transmitted to the tires may be transmitted to the reverse input prevention device 50 through the steering part 30 and the transmission part 20. The external force transmitted to the reverse input prevention device 50 may act as a force for rotating the output part 54.

According to an embodiment, the external force may act as a force for rotating the output part 54 in the first direction (e.g., counterclockwise). The external force may act as a force for the output gear body 541 to rotate in the first direction around the input shaft center 521C. When the output gear body 541 rotates in the first direction around the input shaft center 521C, a second reaction force may be generated in the output disk teeth 532T that mesh with the output gear grooves 542 of the output gear body 541.

The second reaction force is illustrated by a second reaction force reference line F2 which is a virtual line (refer to FIG. 13). The second reaction force may act as a force for rotating the output disk 532 in the first direction. As the second reaction force attempts to rotate the output disk 532 in the first direction, the input disk 531 rotating in conjunction with the output disk 532 may also rotate in the first direction.

The input disk 531 to rotate in the first direction by the second reaction force may contact the disk housing grooves 511 that mesh with the input disk teeth 531T to generate a first reaction force.

The first reaction force is illustrated by the first reaction force reference line F1 which is a virtual line (refer to FIG. 13). The second reaction force may act as a force to rotate the input disk 531 in the second direction opposite to the first direction.

As the first reaction force attempts to rotate the input disk 531 in the second direction, the disk part 53 stops between the disk housing 51 and the output part 54. That is, the output part 54 to be rotated by the external force may not rotate and may be stopped by the disk part 53 stopped by the disk housing 51.

Through the above configuration, the output part 54 may not rotate due to the external force. Therefore, in the reverse input prevention device 50, the disk part 53 and the output part 54 are rotated by the rotation of the input part 52, but the rotation of the input part 52 may be prevented by the rotation of the output part 54.

The reverse input prevention device 50 has a function of a reducer and transmits a driving force from the input part 52 to the output part 54, but may block transmission of the external force from the output part 54 to the input part 52.

FIG. 14 is a perspective view of a rear wheel steering device 1 according to another embodiment of the present disclosure.

In FIG. 14, a first gear 201 and a second gear 202 that mesh with each other are shown in the rear wheel steering device 1, but the rear wheel steering device 1 may include the first gear 201, a belt 203 that meshes with the first gear 201, and the second gear 202 that meshes with the belt 203.

Embodiments of the first gear 201 and the second gear 202 are not limited thereto, and may include a lead screw, a ball screw, a rack gear, a pinion gear, and the like.

Although exemplary embodiments of the present disclosure have been disclosed for illustrative purposes, those skilled in the art will appreciate that various modifications, additions and substitutions are possible, without departing from the scope and spirit of the present disclosure as defined in the accompanying claims. Thus, the true technical scope of the present disclosure should be defined by the following claims.

What is claimed is:

1. A reverse input prevention device comprising:
a disk housing including a plurality of disk housing grooves;
an input part disposed in the disk housing and configured to rotate around a rotation shaft;
a disk part configured to revolve around the rotation shaft by rotation of the input part and rotate by contacting the plurality of disk housing grooves; and
an output part including a plurality of output gear grooves in contact with the disk part and configured to rotate around the rotation shaft.

2. The reverse input prevention device as claimed in claim 1, wherein the input part comprises:
an input shaft extending in a direction parallel to the rotation shaft; and
an eccentric shaft connected to the input shaft and configured to revolve around the rotation shaft by rotation of the input shaft.

3. The reverse input prevention device as claimed in claim 1, wherein:
the disk part comprises a disk body having a disk body hole, and
the input part is inserted into the disk body hole.

4. The reverse input prevention device as claimed in claim 3, wherein the disk body comprises:
an input disk including a plurality of input disk teeth in contact with the plurality of disk housing grooves; and
an output disk including a plurality of output disk teeth in contact with the plurality of output gear grooves and configured to rotate in conjunction with the input disk.

5. The reverse input prevention device as claimed in claim 4, wherein a number of the plurality of disk housing grooves is greater than that of the plurality of input disk teeth.

6. The reverse input prevention device as claimed in claim 4, wherein a number of the plurality of input disk teeth is greater than that of the plurality of output disk teeth.

7. The reverse input prevention device as claimed in claim 1, wherein the output part comprises:
an output shaft extending in a direction parallel to the rotation shaft and configured to rotate around the rotation shaft; and
an output gear body connected to the output shaft, configured to rotate by contacting the output disk of the rotating disk part, and including the plurality of output gear grooves.

8. The reverse input prevention device as claimed in claim 6, wherein a number of the plurality of output gear grooves is greater than that of the plurality of output disk teeth disposed on the output disk.

9. The reverse input prevention device as claimed in claim 1, wherein:
an angular speed of the rotating input part is greater than that of the rotating output part,
a driving force transmitted through the input part rotates the disk part and the output part, and
an external force transmitted through the output part is prevented from being transmitted to the output part, the disk part, and the input part.

10. A rear wheel steering device comprising:
a driving part configured to generate a driving force;
a transmission part connected to the driving part and configured to transmit the driving force;
a steering part connected to the transmission part and configured to adjust a steering angle by the driving force; and
a reverse input prevention device disposed between the driving part and the transmission part and configured to prevent a reverse input transmitted from the transmission part to the driving part,
wherein the reverse input prevention device comprises:
a disk housing having a plurality of disk housing grooves;
an input part disposed in the disk housing and configured to rotate around a rotation shaft;
a disk part configured to revolve around the rotation shaft by rotation of the input part and rotate by contacting the plurality of disk housing grooves; and
an output part including a plurality of output gear grooves in contact with the disk part and configured to rotate around the rotation shaft.
